(19) United States
(12) Patent Application Publication
(10) Pub. No.: US 2012/0163270 A1
(43) Pub. Date: Jun. 28, 2012

(54) WIRELESS COMMUNICATION SYSTEM FOR PROVIDING DIVERSITY GAINS FOR MULTICAST SERVICES AND METHOD FOR PROVIDING MULTICAST SERVICES USING THE SYSTEM

(75) Inventors: Sun-Sim CHUN, Daejeon-si (KR); Young-II Kim, Daejeon-si (KR); Yong-Su Lee, Daejeon-si (KR); Dae-Geun Park, Daejeon-si (KR); Yeon-Joon Chung, Daejeon-si (KR); Young-Soo Park, Daejeon-si (KR)

(73) Assignee: ELECTRONICS AND TELECOMMUINCATIONS RESEARCH INSTITUTE, Daejeon (KR)

(21) Appl. No.: 13/314,707

(22) Filed: Dec. 8, 2011

(30) Foreign Application Priority Data
Dec. 23, 2010 (KR) 10-2010-0133820

(51) Int. Cl. H04H 20/71; H04W 92/00; H04B 7/14

(52) U.S. Cl. 370/312

(57) ABSTRACT

There are provided a wireless communication system for providing diversity gains for multicast services and a method of providing a multicast service. According to the wireless communication system, by transmitting, when terminals are partially distributed in each cell, data to areas where no user exists so as to reduce interference between other MBS (Multicast Broadcast System) zones and other cells that transmit only unicast services, performance deterioration may be minimized.

### CROSS-REFERENCE TO RELATED APPLICATION

This application claims the benefit under 35 U.S.C. §119(a) of a Korean Patent Application No. 10-2010-0133820, filed on Dec. 23, 2010, the entire disclosure of which is incorporated herein by reference for all purposes.

### BACKGROUND

1. Field

The following description relates to a wireless communication system, and more particularly, to a wireless communication system for providing diversity gains for multicast services, and a method for providing multicast services using the system.

2. Description of the Related Art

Base stations of cells forming a Multimedia Broadcast/Multicast Service over a Single Frequency Network (MBSFN) each transmits the same data to all terminals that exist in the corresponding cell. At this time, terminals located on the boundaries of the cells receive data transmitted from other base stations than a base station to which the terminals belong.

IMT-Advanced requirements for the development of 4 generation wireless communication support a peak data rate of 1 Gbps to users that use a low data rate and a peak data rate of 100 Mbps to users that use a high data rate. In order to meet the IMT-Advanced requirements, a 802.16m-based WiMax 2.0 system and a 3GPPLTE-Advanced system apply a MultiCarrier (MC) technique and a Carrier Aggregation (CA) technique to their standards.

A 3GPP2 (1xEV-DO REVB, HSPA) standard also applies the CA technique by binding a plurality of bandwidths having a fixed size, such as 1.25 MHz (1Xev-DO) and 5 MHz (HSPA).

However, the MC technique that is applied to the 802.16m and LTE-Advanced standards has differentiated characteristics from that applied to the 3GPP2 standard. In more detail, base stations all support multiple RF carriers, the bandwidth of each carrier has no fixed size, and the bands of carriers do not need to be seamless.

According to deployment of carriers defined in the 802.16m standard, ABS can deploy carriers differently for each cell depending on the configuration of each carrier. ABS allocates a partially configured carrier to each terminal in order to avoid a fully configured carrier and further improve performance.

Carriers have the following meanings.

A fully configured carrier transmits all control channels related to synchronization, broadcast, multicast, and unicast. Also, since the fully configured carrier is a standalone carrier, it supports individual AMSs (that is, terminals) in the forms of a single carrier and a multicarrier.

Meanwhile, a partially configured carrier cannot operate as a standalone carrier, transmits only limited channels, and mainly transmits downlink traffic.

The LTE-Advanced standard configures CA deployment scenarios, with focusing on deploying Component Carriers (CCs) according to the need of operators. The CA deployment scenarios for the LTE-Advanced standard have characteristics as follows.

Each scenario will be described under an assumption that two CCs (F1 and F2, F1<F2) are provided, below.

eNB (base station) allocates F2 to each terminal in order to avoid a fully configured carrier F1 and further improve performance, or F2 is used for extension of cell areas, cell boundaries, and hot spot areas.

Scenario 1: F1 and F2 both have the nearly same cell coverage, and the antennas of eNBs for individual CCs are located at the same place and have the same beam direction and pattern. F1 and F2 have adjacent frequencies.

Scenario 2: similar to Scenario 1 except that F1 and F2 have different cell coverages.

Scenario 3: individual CCs have different beam directions. It improves throughput at cell boundary areas, and the antenna of F2 is oriented to the cell boundary area of F1.

Scenario 4: F1 provides macro coverage, and F2 provides traffic hot spot (RRH cell) coverage. eNB connects to RRH through an optical cable.

Scenario 5: similar to Scenario 2, and a frequency selective repeater, which increases only power of specific CCs, is additionally installed to extend coverage of F2 frequency band.

However, the above-mentioned standards consider no applicability of MC deployment for multicast services.

### SUMMARY

The following description relates to a technique for improving the performances of terminals located on cell boundaries by providing diversity gains in a MBSFN (MBMS over a Single Frequency Network).

The following description also relates to a technique of transmitting, when terminals are partially distributed in each cell, data to areas where no user exists so as to reduce interference between other MBS (Multicast Broadcast System) zones and other cells that transmit only unicast services, thereby minimizing performance deterioration.

The following description also relates to a control method for improving the performance of terminals that use a multicast service supporting no re-transmission method (HARQ, ARQ) when only terminals belonging to an area in a cell require a multicast service without configuring a MBSFN.

The following description also relates to a method of providing, when a multicast service is requested from an area in a cell, diversity gains to terminals belonging to the area without having to use MBSFN transmission.

In one general aspect, there is provided a wireless communication system for providing diversity gains for multicast services, including: a relay to transmit/receive data to/from terminals that exist in a cell on the wireless communication system, using a predetermined frequency band that is decided depending on a distribution of the terminals; and a base station to transmit/receive data to/from the terminals and the relay, using a frequency band that is different from the predetermined frequency band used by the relay.

The base station configures a cell having a predetermined area, the relay is disposed in the cell configured by the base station, and the cell is divided into a plurality of sectors.

The relay is disposed near a terminal that is farthest from the base station among the terminals in the cell.

The relay is disposed in consideration of a location of a terminal among the terminals in the cell, the terminal being under a unstable communication state with the base station, and the relay transmits the data received from the base station to the terminal.

The relay transmits the data to the terminal using a predetermined frequency band that covers an area narrower than the cell configured by the base station, the predetermined frequency band decided in consideration of a distance between the terminal and the base station.

The base station selects a MC physical link and a location of the relay, according to locations where the terminals exist in a sector on the cell, the sector configured by the base station.

The relay communicates with the base station through a multicarrier (MC) physical link CF1, the relay communicates with the terminal through a MC physical link CF3, and the CF3 belongs to a higher frequency domain than that of the CF1 and has smaller cell coverage than that of the CF1.

Also, when a Multicast Broadcasting System (MBS) zone is configured by a base station and terminals that want to use a multicast service exist in a part of the MBS zone, the base station transmits data to the relay and the terminals through the CF1, and the relay transmits data received from the base station to a terminal that is in a specific direction from the relay through CF3.

Also, when a MBS zone is configured by a base station and terminals that want to use a multicast service are distributed in different areas in the MBS zone, a relay is disposed near a terminal that is farthest from the base station, data is transmitted to terminals and the relay through CF2, and the relay transmits data received from the base station to the terminals through CF3.

Also, when terminals that want to use a multicast service exists in a part of a MBS zone, the base station transmits data to the terminals through CF1.

When a Multicast Broadcasting System (MBS) zone is configured by the base station, and terminals that want to use the multicast service exist for each a sector on the MBS zone, the relay is disposed for each sector.

Terminals that exist in a cell configured by the base station include at least one terminal that wants to use a unicast service and at least one terminal that wants to use a multicast service.

In another general aspect, there is provided a method of proving a multicast service in a wireless communication system that includes a base station and a relay, including: at a terminal, receiving data from the base station; at the terminal, receiving data from the relay; and at the terminal, processing the data received from the base station and the relay, in consideration of reception delay times of the received data.

The receiving of the data from the base station includes receiving the data using a predetermined frequency band that is decided according to a location of a terminal that exists in a cell on the wireless communication system.

The receiving of the data from the relay includes receiving the data using a frequency band that is different from the predetermined frequency band.

The receiving of the data from the base station includes receiving the data through a multicarrier (MC) physical link CF2, when terminals exist at different areas in a MultiBroadcasting System (MBS) zone.

The receiving of the data from the relay includes receiving the data from a relay disposed near a terminal that is farthest from the base station, through a MultiCarrier (MC) physical link CF3.

The method further includes, at the base station, transmitting the data to the terminal or the relay, wherein the transmitting of the data to the terminal or the relay comprises at the base station, transmitting, when a terminal that wants to use the multicast service exists on a boundary of a MultiBroadcasting System (MBS) zone, the data to the terminal through a MultiCarrier (MC) physical link CF1.

In another general aspect, there is provided a method of providing a multicast service, including: disposing at least one relay according to locations where terminals that want to use a multicast service exist in a Multicast Broadcasting System (MBS) zone; and transmitting data to the terminals or the relay.

Accordingly, by applying MC deployment with a relay in consideration of the characteristics of multicast services, without having to configure a MBSFN, time-delay diversity gains may be provided to terminals. Also, a re-transmission function, such as HARQ and ARQ, may be provided to terminals that are under poor wireless channel conditions.

Furthermore, narrow cell coverage of a relay reduces interference to neighboring cells, which results in improvement of performance, thereby achieving effective use of mobile resources.

Data received through a relay is again transmitted to terminals.

Therefore, although many mobile resources are used, multicast services may be provided with high efficiency.

Other features and aspects will be apparent from the following detailed description, the drawings, and the claims.

### BRIEF DESCRIPTION OF THE DRAWINGS

FIG. 1 is a view for explaining an example where a multicast service is provided to terminals that exist in specific areas of cells forming a Multicast Broadcast System (MBS) area.

FIG. 2 is a view for explaining an example where a multicast service is provided to terminals that exist in specific areas of a cell.

FIG. 3 illustrates the ranges of cells that are covered by a base station and relays on a wireless communication system.

FIG. 4 is a block diagram illustrating an example of a wireless communication system.

FIG. 5 is a view for explaining a method of providing a multicast service to terminals in cells forming a MBS area.

FIGS. 6A, 6B and 6C are procedural views for explaining the method of providing the multicast service.

FIG. 7 is a view for explaining a method of providing a multicast service to terminals in a cell.

FIG. 8 is a view for explaining a method of dividing a cell into a plurality of sectors to provide a multicast service to terminals in each sector.

FIG. 9 is a flowchart illustrating an example of a method of providing a multicast service. Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

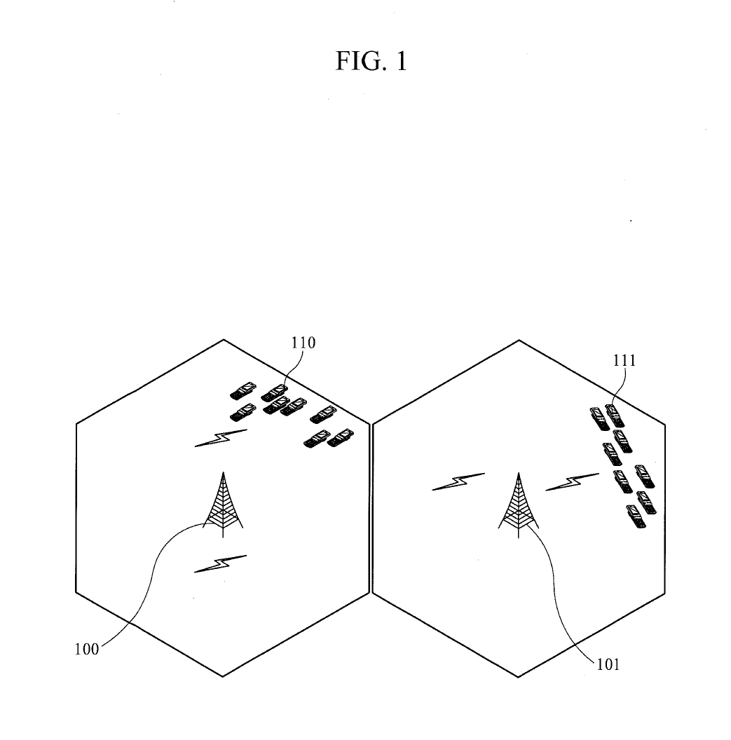

FIG. 1 is a view for explaining an example where a multicast service is provided to terminals that exist in specific areas of cells forming a Multicast Broadcast System (MBS) area.

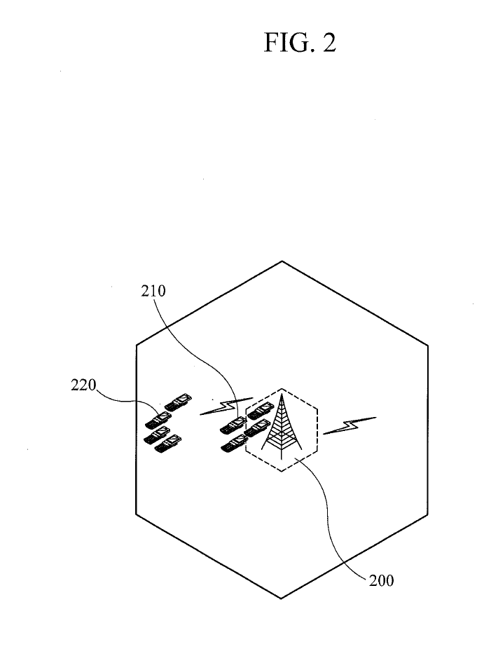

FIG. 2 is a view for explaining an example where a multicast service is provided to terminals that exist in specific areas of a cell.

FIG. 1 illustrates the case where a multicast service is provided in a MBS area composed of a plurality of cells, and FIG. 2 illustrates the case where a multicast service is provided in a single cell. The following description will be given with reference to FIGS. 1 and 2.

As Multi-Carrier (MC) deployment, it has been used a method of allocating a secondary carrier (SC, that is, a partially configured carrier) for additional performance improvement or for extension of cell areas, cell boundaries, and hot spot areas, when carrier resources being used as a primary carrier (PC) are fully occupied.

However, the method has disadvantage in view of diversity gain, etc. when multicast services are provided, and accordingly, the present inventor proposes a method of providing a function similar to re-transmission to terminals (for example, terminals illustrated in FIG. 1 or 2).

Also, MC deployment of assigning a plurality of MCs having different cell coverages at the same time to a single piece of multicast data is used.

First, a general method of providing a multicast service will be described with reference to FIGS. 1 and 2, below. Referring to FIGS. 1 and 2, base stations 100, 101, and 200 provide a is multicast service by allocating SC to the entire areas of cells regardless of the locations of terminals 110, 111, 210 and 220 in the cells.

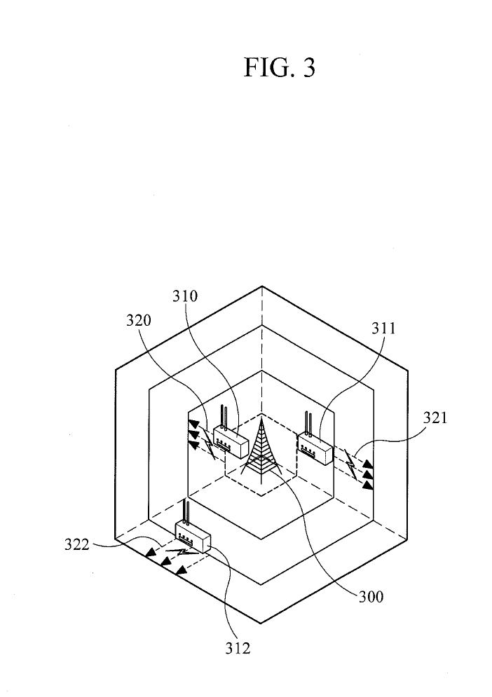

FIG. 3 illustrates the ranges of cells that are covered by a base station and relays on a wireless communication system.

Referring to FIG. 3, the base station 300 and the relays 310, 311, and 312 use different MCs, and are wirelessly connected to each other. Cell ranges covered by the relays 310, 311, and 312 are significantly shorter than a cell range covered by the base station 300, and the relays 310, 311, and 312 are under the control of the base station 300.

As illustrated in FIG. 3, the base station 300 has coverage over the entire cell area, and the relays 310, 311, and 312 have coverage over cell areas represented by arrows 320, 321, and 322, respectively.

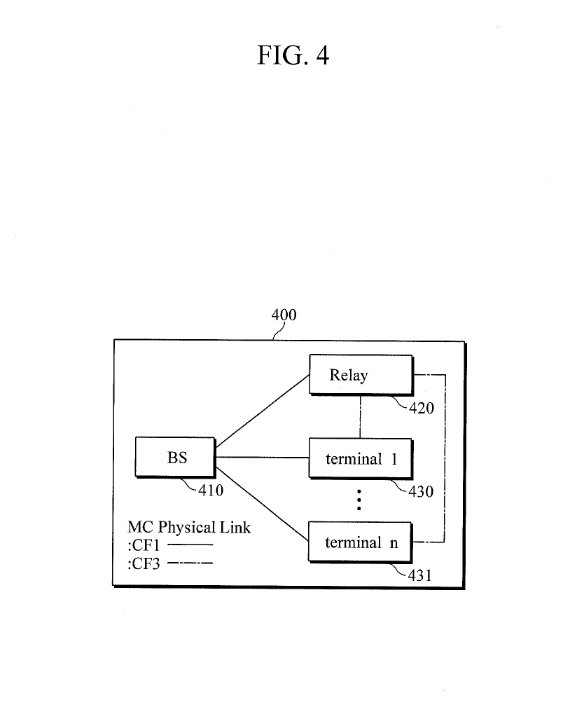

FIG. 4 is a block diagram illustrating an example of a wireless communication system 400. Referring to FIG. 4, the wireless communication system 400 may include a base station 410, a relay 420, and a plurality of terminals 430, . . . , 431.

When the terminals 430 and 431 request the base station 410 to provide a multicast service, the base station 410 transmits the corresponding data to the terminals 430 and 431 and the relay 420 through a MC physical link CF1. An RF frequency band used by the base station 410 is dependent on the locations of the terminals 430 and 431 that have requested provision of the multicast service.

In other words, the base station 410 uses an RF frequency band having the longest cell coverage when the terminals 430 and 431 are located near the boundary of a cell, and uses an RF frequency band having the shortest cell coverage when the terminals 430 and 431 are located near the center of a cell.

Also, the base station 410 selects the relay 420 that is closest to the terminals 430 and 431, allocates different MCs to transmission/reception frequency bands of the relay 420, and also causes the relay 420 to again transmit data received from the base station 410 to the terminals 430 and 431 with a time difference, thereby providing time-delay diversity gains to the terminals 430 and 431.

The base station 410 also selects the relay 420 depending on the locations of the terminals 430 and 431. Specifically, the base station 410 selects the relay 420 closest to a terminal (that is, a terminal that is under poor wireless channel conditions) that is farthest from the base station 410. If the terminals 430 and 431 are located close to the base station, there may be no relay 420.

The terminals 430 and 431 and the relay 420 receive the data transmitted from the base station 410, and the relay 420 transmits the received data to the terminals 430 and 431. At this time, the relay 420 uses an RF transmission frequency band having cell coverage that is shorter than cell coverage of a frequency band used by the base station 410 and that is suitable for covering a difference in distance between the terminals 430 and 431 with respect to the relay 420.

FIG. 4 shows the case where the base station 410 connects to the relay 420 through a MC physical link CF1, and the relay 420 connects to the terminals 430 and 431 through a MC physical link CF3.

The MC physical link CF3 belongs to a high-frequency area compared to the MC physical link CF1, and cell coverage of the MC physical link CF3 is significantly narrower than that of the MC physical link CF1. A plurality of MCs having different cell coverages are used to provide time-delay diversity.

Basically, the relay 420 performs the same function as a conventional relay of transmitting data received from a base station to terminals, however, the relay 420 relays data using a frequency band that is shorter than a frequency band received from the base station, instead of using the frequency band received from the base station.

The current example is implemented under the following assumption.

Cells operate in the state where unicast users and multicast users coexist. It is assumed that unicast users already exist, and they are not illustrated in the drawings. Terminals that want to use a multicast service first perform a procedure for call setup. After the terminals perform the procedure for call setup using a carrier frequency 1 (CF1) that functions as a primary carrier (PC), the terminals request multicast services.

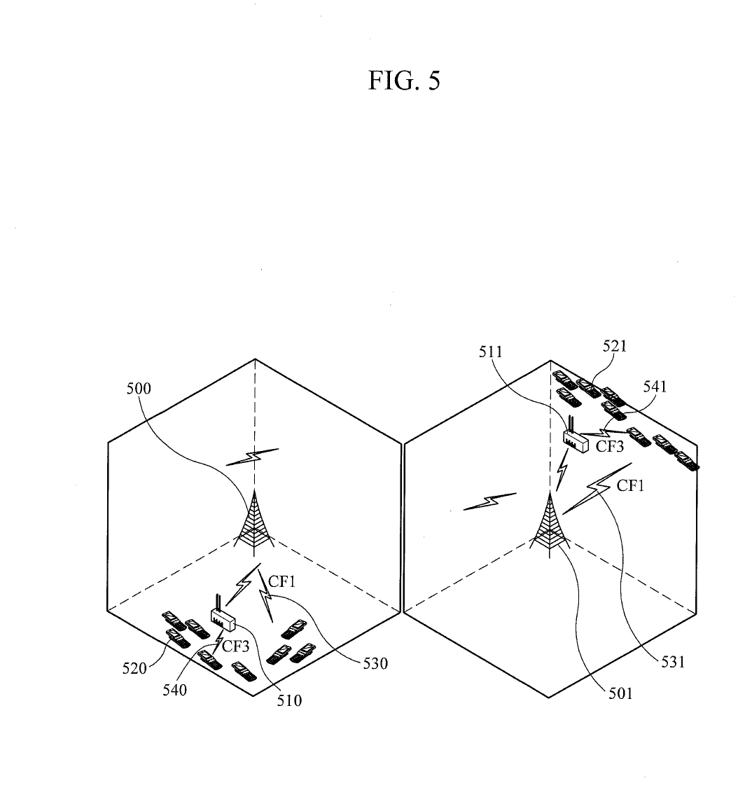

FIG. 5 is a view for explaining a method of providing a multicast service to terminals in cells forming a MBS zone.

Referring to FIG. 5, a base station 500 can use CF1 530 and 531 at the same time and a base station 501 can use CF3 540 and 541 at the same time. The MBS zone is composed of the base stations 500 and 501, and terminals 520 and 521 that want to use a multicast service are located near the boundaries of cells. Relays 510 and 511 having a directional transmission/reception function are located as illustrated in FIG. 5. As described above, the relays 510 and 511 are selected depending on the locations of terminals that are farthest from the base stations 500 and 501, respectively.

The base station 500 transmits data to the terminals 520 and the relay 510 through CF1 530, and the relay 510 transmits the data to the terminals 520 through CF3 540.

Also, the base station 501 transmits data to the terminals 521 and the relay 511 through CF1 531, and the relay 511 transmits the data to the terminals 521 through CF3 541. That is, the base station 501 enables transmission of multicast data through CF3, instead of transmitting such multimedia data only through CF1.

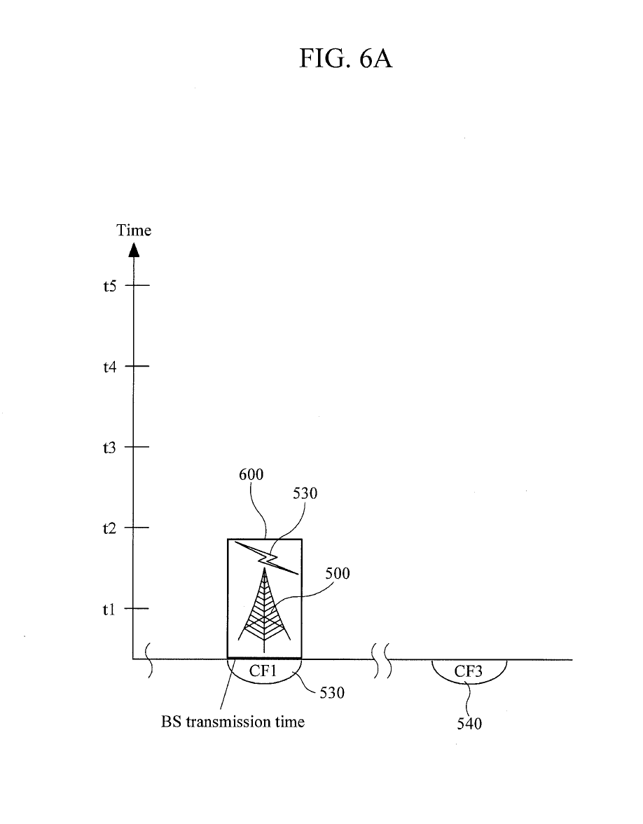

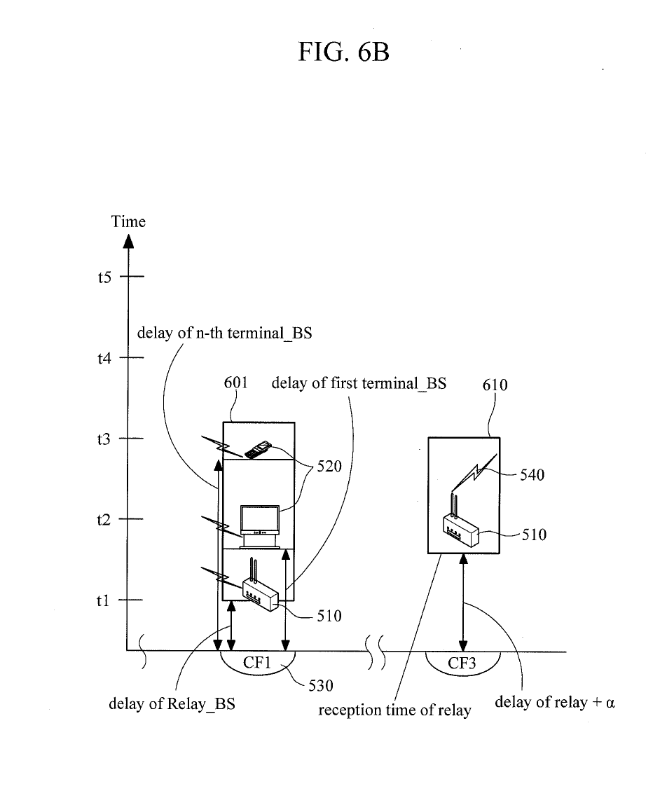

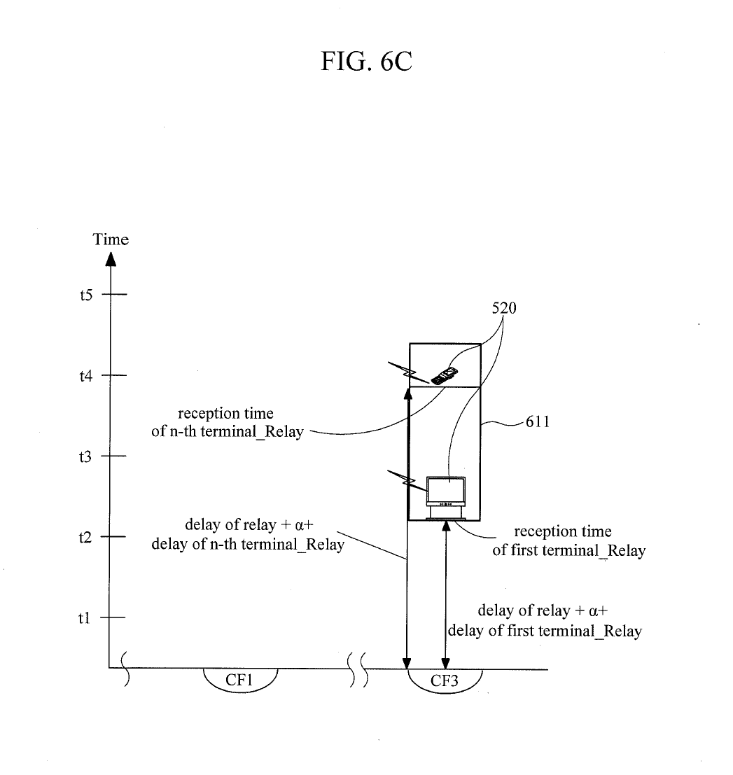

FIGS. 6A, 6B and 6C show a procedure in which the method described above with reference to FIG. 5 is performed over time.

Referring to FIGS. 5 and 6A, the base station 500 transmits data 600 to the terminals 520 (in the current example, also referred to as first and n-th terminals) and the relay 510 through CF1 530.

Then, referring to FIGS. 5 and 6B, the terminals 520 and the relay 510 receive data 601 through CF1 530 after their individual delay times (delay of relay_BS, delay of first terminal_BS, delay of n-th terminal_BS) elapse.

Then, after the delay of relay_BS and a processing time a of the relay 510 elapse, the relay 510 transmits the received data 601 to the individual terminals 520 through CF3 540.

Next, referring to FIGS. 5 and 6C, the first or n-th terminal 520 receives the data 611 transmitted from the relay 510 after the delay time between the first or n-th terminal 520 and the relay 510, the delay of the relay 510, and the processing time a of the relay 510 (that is, (delay of first terminal_BS or delay of n-th terminal_BS)+(delay of relay_BS)+(α)) elapse. That is, the terminals 520 receive the data 601 from the base station 500 and then again receive data 611 from the relay 510 after a predetermined time elapses.

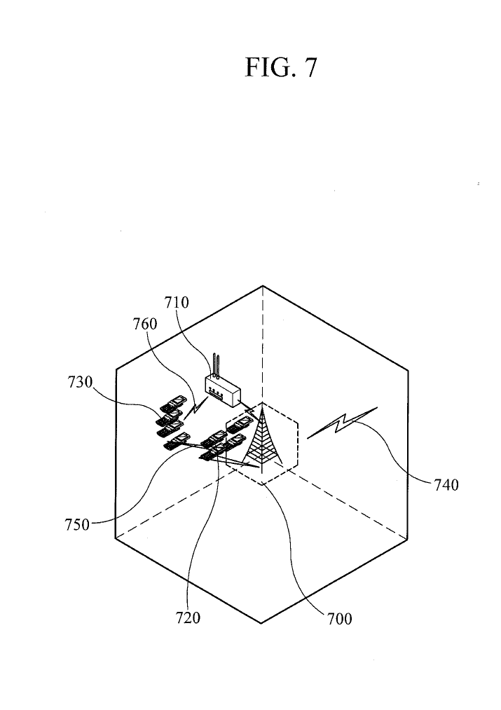

FIG. 7 is a view for explaining a method of providing a multicast service to terminals in a cell, and in more detail, FIG. 7 is a view for explaining a method of providing a multicast service when a terminal 720 is located near a base station 700 and another terminal 730 is located near the center of a cell in the same sector.

The base station 700 can use all of CF1 740, CF2 750 and CF3 760. The base station 700 transmits multicast data information to the relay 710 and the terminals 720 and 730 that want to use a multicast service, through CF2 750, wherein CF2 750 is decided depending on which one of the terminals 720 and 730 makes a greater difference in distance from the base station 700. The relay 710 is also selected depending on the locations of terminals that are relatively farthest from the base station 700. The relay 710 receives signals from the base station 700 through CF2 750, and transmits signals to the terminals 720 and 730 through CF3 760.

Details on a temporal procedure in which the base station 700 and the relay 710 transmit multicast data information to the terminals 720 and 730 have been described above with reference to FIGS. 6A, 6B, and 6C.

The example described above with reference to FIG. 7 uses carrier switching MC deployment from CF1 (transmitting information required for call setup) to CF2, and provides CA deployment that allows transmission of multicast data through CF3, the multicast data having been transmitted only through CF2.

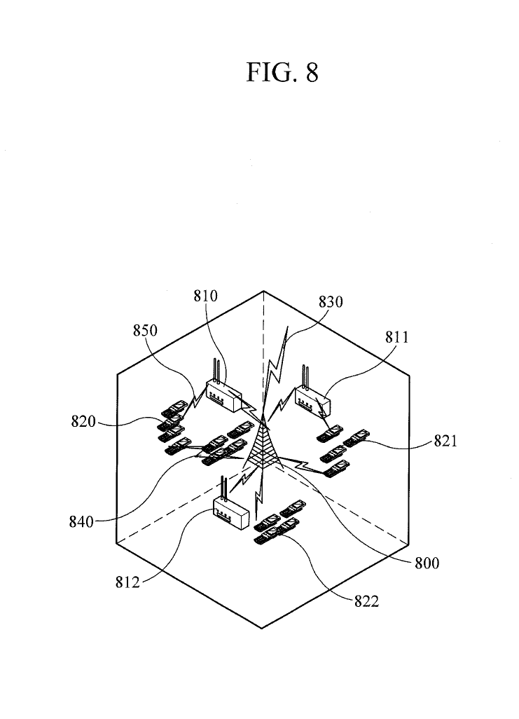

FIG. 8 is a view for explaining a method of dividing a cell into a plurality of sectors to provide a multicast service to terminals 820, 821, and 822 in each sector.

FIG. 8 illustrates the case where when the terminals 820, 821, and 822 in all the sectors are located a specific distance away from a base station 800, a multicast service is provided to the terminals 820, 821, and 822.

When CF1 830, CF2 840, and CF3 850 can be all used, the base station 800 transmits multicast data information to relays 810, 811, and 812 and the terminals 820, 821, and 822 that want to receive a multicast service, through CF2 840, wherein CF2 840 is decided depending on which one of the terminals 820, 821, and 822 makes a greater difference in distance from the base station 800. The example illustrated in FIG. 8 is different from that illustrated in FIG. 7 in that the terminals 820, 821, and 822 illustrated in FIG. 8 are located in respective sectors and accordingly the relays 810, 811, and 812 are also provided for the respective sectors.

Details on a temporal procedure in which the base station 800 and the relays 810, 811, and 812 transmit multicast data information to the terminals 820, 821, and 822 have been described with reference to FIGS. 6A, 6B, and 6C.

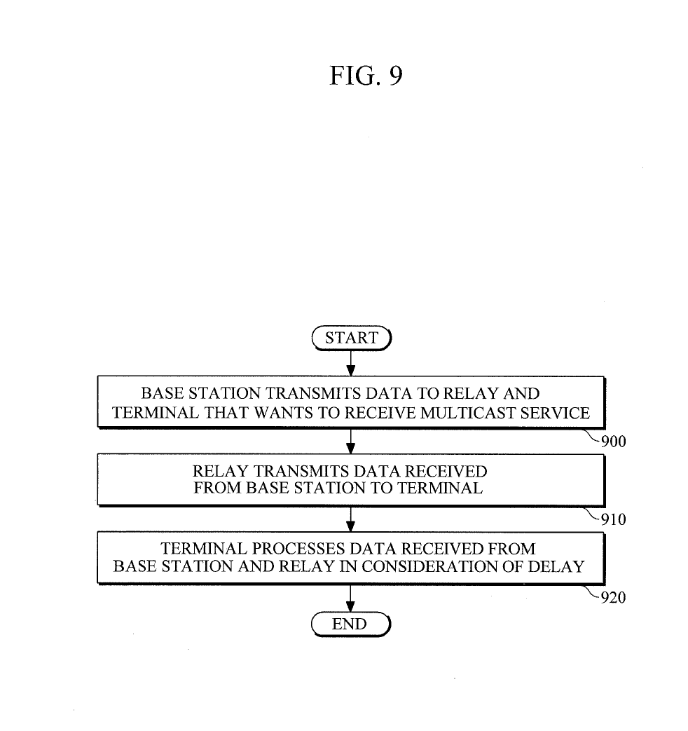

FIG. 9 is a flowchart illustrating an example of a method of providing a multicast service.

FIG. 9 corresponds to a process of providing a multicast service through a wireless communication system including a base station and at least one relay.

First, the base station transmits data to a relay or a terminal that wants to receive a multicast service (900).

Then, the relay transmits the received data to the terminal (910).

The terminal processes the received data in consideration of the delay times of the individual pieces of data received from the base station and the relay, thus receiving the multicast service (920).

Also, in operation 900, the base station transmits/receives data to/from the relay or the terminal that exists in a cell on a wireless communication system, using a predetermined frequency band that is decided depending on the location of the terminal, and in operation 910, the relay transmits the data received from the base station to the terminal, using a frequency band that is different from the predetermined frequency band used by the base station.

Also, in operation 900, when terminals that want to use a multicast service exist at different locations in a Multicast Broadcasting System (MBS) zone configured by the base station, a relay is disposed near the terminal that is farthest from the base station, and the base station transmits data to the terminals or the relay through a MC physical link CF2.

In operation 910, the relay transmits the data received from the base station to the terminal through a MC physical link CF3.

Furthermore, in operation 900, when the terminal that wants to use the multicast service is located at the boundary of the MBS zone, the base station transmits the data to the terminal through a MC physical link CF1.

In addition, relays may be disposed in consideration of the locations of terminals that want to use the multicast service on the MBS zone configured by the base station.

The methods as described above can also be embodied as computer readable codes on a computer-readable storage medium. Codes and code segments for accomplishing the present invention can be easily construed by programmers skilled in the art to which the present invention pertains. The computer-readable storage medium is any data storage device that can store data which can be thereafter read by a computer system. Examples of the computer-readable storage medium include ROMs, RAMs, CD-ROMs, magnetic tapes, floppy disks, optical disks, etc. The computer-readable storage medium can also be distributed over network coupled computer systems so that the computer readable codes are stored and executed in a distributed fashion.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A wireless communication system for providing diversity gains for multicast services, comprising:
a relay to transmit/receive data to/from terminals that exist in a cell on the wireless communication system, using a predetermined frequency band that is decided depending on a distribution of the terminals; and
a base station to transmit/receive data to/from the terminals and the relay, using a frequency band that is different from the predetermined frequency band used by the relay.

2. The wireless communication system of claim 1, wherein the base station configures a cell having a predetermined area, the relay is disposed in the cell configured by the base station, and the cell is divided into a plurality of sectors.

3. The wireless communication system of claim 1, wherein the relay is disposed near a terminal that is farthest from the base station among the terminals in the cell.

4. The wireless communication system of claim 1, wherein the relay is disposed in consideration of a location of a terminal among the terminals in the cell, the terminal being under a unstable communication state with the base station, and the relay transmits the data received from the base station to the terminal.

5. The wireless communication system of claim 1, wherein the relay transmits the data to the terminal using a predetermined frequency band that covers an area narrower than the cell configured by the base station, the predetermined frequency band decided in consideration of a distance between the terminal and the base station.

6. The wireless communication system of claim 1, wherein the base station selects a MC physical link and a location of the relay, according to locations where the terminals exist in a sector on the cell, the sector configured by the base station.

7. The wireless communication system of claim 1, wherein when a terminal that wants to use the multicast service is located in a part of a Multicast Broadcasting System (MBS) zone, the base station transmits data to the terminal through a MultiCarrier (MC) physical link CF1.

8. The wireless communication system of claim 1, wherein when a Multicast Broadcasting System (MBS) zone is configured by the base station, and terminals that want to use the multicast service exist for each a sector on the MBS zone, the relay is disposed for each sector.

9. The wireless communication system of claim 1, wherein terminals that exist in a cell configured by the base station include at least one terminal that wants to use a unicast service and at least one terminal that wants to use a multicast service.

10. A method of proving a multicast service in a wireless communication system that includes a base station and a relay, comprising:
at a terminal, receiving data from the base station;
at the terminal, receiving data from the relay; and
at the terminal, processing the data received from the base station and the relay, in consideration of reception delay times of the received data.

11. The method of claim 10, wherein the receiving of the data from the base station comprises receiving the data using a predetermined frequency band that is decided according to a location of a terminal that exists in a cell on the wireless communication system.

12. The method of claim 11, wherein the receiving of the data from the relay comprises receiving the data using a frequency band that is different from the predetermined frequency band.

13. The method of claim 10, wherein the receiving of the data from the base station comprises receiving the data through a multicarrier (MC) physical link CF2, when terminals exist at different areas in a MultiBroadcasting System (MBS) zone.

14. The method of claim 13, wherein the receiving of the data from the relay comprises receiving the data from a relay disposed near a terminal that is farthest from the base station, through a MultiCarrier (MC) physical link CF3.

15. The method of claim 13, further comprising, at the base station, transmitting the data to the terminal or the relay, wherein the transmitting of the data to the terminal or the relay comprises at the base station, transmitting, when a terminal that wants to use the multicast service exists on a boundary of a MultiBroadcasting System (MBS) zone, the data to the terminal through a MultiCarrier (MC) physical link CF1.

16. A method of providing a multicast service, comprising:
disposing at least one relay according to locations where terminals that want to use a multicast service exist in a Multicast Broadcasting System (MBS) zone; and
transmitting data to the terminals or the relay.

17. The method of claim 16, wherein the transmitting of the data comprises transmitting/receiving the data to/from the terminals or the relay, using a predetermined frequency band that is decided depending on the locations of the terminals that exist in the MBS zone.

18. The method of claim 16, wherein the disposing of the relay comprises disposing, when the terminals exist at different areas in the MBS zone, the relay near a terminal that is farthest from the base station among the terminals.

19. The method of claim 18, wherein the transmitting of the data comprises transmitting the data to the terminals or the relay through a MultiCarrier (MC) physical link CF2.

20. The method of claim 16, wherein the transmitting of the data comprises transmitting, when the terminals are located on a boundary of the MBS zone, the data to the terminals through a MultiCarrier (MC) physical link CF1.
